(19) United States
(12) Patent Application Publication
(10) Pub. No.: US 2008/0023870 A1
(43) Pub. Date: Jan. 31, 2008

(54) METHOD AND APPARATUS FOR SCRAPLESS THERMOFORMING

(75) Inventor: Alan Jordan, Fitchburg, WI (US)

Correspondence Address: FOLEY & LARDNER LLP, 777 EAST WISCONSIN AVENUE, MILWAUKEE, WI, 53202-5306, US

(73) Assignee: Coextruded Plastic Technologies, Inc.

(21) Appl. No.: 11/832,588

(22) Filed: Aug. 1, 2007

Related U.S. Application Data
(63) Continuation-in-part of application No. 10/651,748, filed on Aug. 29, 2003.
(63) Continuation-in-part of application No. 11/080,979, filed on Mar. 15, 2005.
Application No. 11/080,979 is a division of application No. 10/234,278, filed on Sep. 4, 2002, now Pat. No. 6,896,506.

(51) Int. Cl. C04B 41/45

(52) U.S. Cl. 264/132; 425/112

(57) ABSTRACT

A thermoforming system includes a thermoplastic preprinted billet and a thermoforming machine. The thermoforming machine includes a loading station configured to load the preprinted billet onto a frame. The thermoforming machine also includes a heating apparatus configured to heat the preprinted billet and a forming station configured to form the preprinted billet into a container.

This is a continuation-in-part of application Ser. No. 11/080,979, filed Mar. 15, 2005, which is a divisional application of application Ser. No. 10/234,278, filed Sep. 4, 2002, now U.S. Pat. No. 6,896,506, granted May 24, 2005, which is incorporated herein by reference in its entirety. This is also a continuation-in-part of application Ser. No. 10/651,748, filed Aug. 29, 2003, which is incorporated herein by reference in its entirety.

### FIELD

The present invention relates to a scrapless thermoforming process and associated apparatus. In particular, the present invention relates to a system for scrapless thermoforming using a preprinted billet.

### BACKGROUND

A thermoformer or thermoforming machine typically has a series of stages that transform input plastic material into finished containers. The input material is a thermoplastic substance that can be formed when heated. A common thermoplastic material is polypropylene. The finished containers are commonly used to hold food or beverages, and may be formed into a variety of sizes and shapes depending on the thermoforming process that is utilized.

Thermoplastic materials may be fed into a thermoforming machine in the form of a continuous sheet or as individually cut blanks or billets. When the input materials are individual thermoplastic billets, the process is called “scrapless thermoforming” because the finished containers need not be cut from the sheet after forming, reducing the amount of scrap material. In scrapless thermoforming, a billet feeding unit is typically used to load individual billets onto a conveying device in the machine.

Prior to being formed into containers, the billets must be heated to the desired temperature. The desired temperature depends on the structure of the machine being used as well as the desired properties of the end product. For example, containers may be formed while the thermoplastic material is below the crystalline melt point of the material. Such forming is known as solid-phase pressure forming. Other methods involve heating the material to its melting point prior to forming. Such a process is known as melt-phase thermoforming.

A conventional scrapless thermoforming machine has several stages used to create formed containers. First, the billets are loaded into the machine. Second, an oven is used to heat the billets to the desired temperature. Third, a form station or form press utilizes a hydraulic press or other suitable means to form the individual containers. After exiting the form press, the formed containers are removed from the machine at an unloading station. Other stations may be added to the thermoforming machine as desired, such as a pre-heating oven and a coining press to form an initial container edge prior to entry into the main oven. A conveyor is typically used to transport the billets through the various stations.

Whether the containers are formed utilizing solid-phase forming or melt-phase forming, a problem that must be addressed involves the deformation of the thermoplastic material as it is heated. Because the billets are typically supported in a horizontal fashion with only peripheral supports beneath each billet due to the configuration of the form press, the billets tend to sag or droop between the supports when heated. In some cases, the billets may entirely fall out of their supports when heated due to the material deformation.

The thermoforming art has tried many methods of preventing material deformation from adversely impacting the thermoforming process. One method involves minimizing the size of the billets. This method prevents the formation of larger containers. Another method is to utilize round billets such that the resultant uniform deformation allows the support to retain the billet during heating. This method precludes the forming of containers having a non-uniform cross-section, such as rectangular or oval containers. Yet another method of addressing the deformation issue is to utilize a ring placed on top of the billet to strengthen the frictional grip on the billet during heating. This method presents additional manufacturing challenges with respect to how to efficiently place individual rings on top of each billet during the loading process.

An additional problem due to the deformation of the thermoplastic material as it is heated is that any printed design, wording or barcodes on the material is also deformed when heated. One method of solving this problem involves placing all printing on the container after formation. This method results in an extra step in the manufacturing process. Another method involves placing printing on separate packaging that is then placed on or around the formed container. This method results in inefficient “double packaging” that is both costly and time consuming. Yet another method involves placing printing on a billet in non-specific areas, such as a randomly spaced logo or repeating design. However, this method does not allow for preprinting of detailed information at specific locations on the formed container, such as barcodes, nutritional information, and company information.

Accordingly, there is a need for a thermoforming system that addresses the problems of billet deformation and packaging efficiency. Further, it would be advantageous to have a solution for the billet deformation problem that permits the formation of larger sized containers or containers having non-uniform shapes. Further still, it would be advantageous to address the problem of billet deformation without adversely impacting the efficiency of the overall process or requiring additional equipment and components. Additionally, there is a need for a system for creating a thermoformed container having detailed information placed in specific locations on the formed container.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY

The invention relates to a thermoforming system having a thermoplastic preprinted billet and a thermoforming machine. The thermoforming machine includes a loading station configured to load the preprinted billet onto a frame, a heating apparatus configured to heat the preprinted billet, and a forming station configured to form the preprinted billet into a container.

The invention further relates to a method of using a thermoforming system. The method includes the steps of loading the preprinted billet onto the frame, heating the preprinted billet to a temperature suitable for thermoforming and forming a container from the preprinted billet.

The invention still further relates to a method of forming a container. The method includes the steps of providing a plastic preprinted billet and loading the preprinted billet onto a frame in a thermoforming machine. The method further includes the step of heating the preprinted billet to a temperature suitable for thermoforming and forming a container from the preprinted billet.

The invention is capable of other embodiments and of being practiced or being carried out in various ways. Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a schematic illustration of a thermoforming machine;

FIG. 2 is a top view of a frame without a billet;

FIG. 3 is a sectional view of a frame having a billet disposed therein;

FIG. 4 is a sectional view of a frame having a coined billet disposed therein;

FIG. 5 is a sectional view of a frame having a heated billet disposed therein; and

FIG. 6 is a partial sectional view of a form press.

FIG. 7 is a bottom view of a preprinted billet, according to an exemplary embodiment.

FIG. 8 is a bottom view of a container formed from a preprinted billet, according to an exemplary embodiment.

FIG. 9 is a side view of a container formed from a preprinted billet, according to an exemplary embodiment.

### DESCRIPTION OF PREFERRED EMBODIMENTS

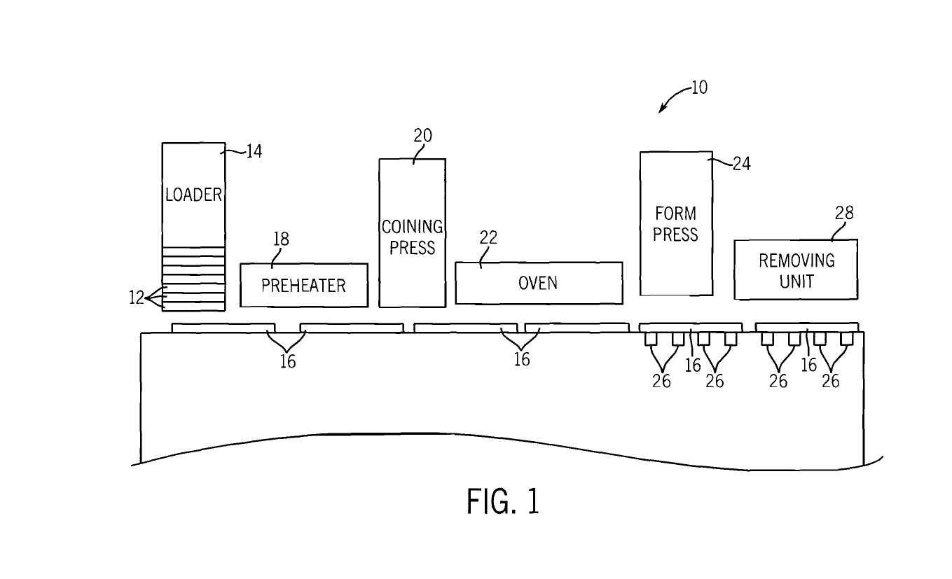

Referring to FIG. 1, a thermoforming machine, shown as thermoformer 10, includes several stages configured to transform input thermoplastic materials into formed containers. In the scrapless thermoforming embodiment shown in FIGS. 1-6, the input materials are thermoplastic blanks, shown as billets 12. In one embodiment, the billets 12 may be preprinted thermoplastic blanks.

A loading station, shown as loader 14, is configured to load billets 12 onto a conveyor, having a conveying mechanism, shown as transport tray 16, for movement through the stations of thermoformer 10.

In an exemplary embodiment, a preheating station, shown as pre-heater 18, may be utilized to perform initial heating of the billets 12. Such initial heating may be desired when a coining press 20 is utilized to create an initial structure on the billet 12, such as adding a rim around the peripheral edge of billet 12. The pre-heater 18 may be suitable to heat billet 12 to a temperature permitting solid-phase thermoforming in the coining press 20.

After exiting the coining press 20, if utilized, the transport tray 16 is shuttled through a heating apparatus, shown as oven 22. The oven 22 heats the billets 12 to the desired temperature prior to entry into a thermoforming press, shown as forming station or form press 24. The desired temperature is dependent on the thermoplastic material used. In a preferred embodiment, solid-phase thermoforming is performed at a temperature below the crystalline melt temperature of billet 12.

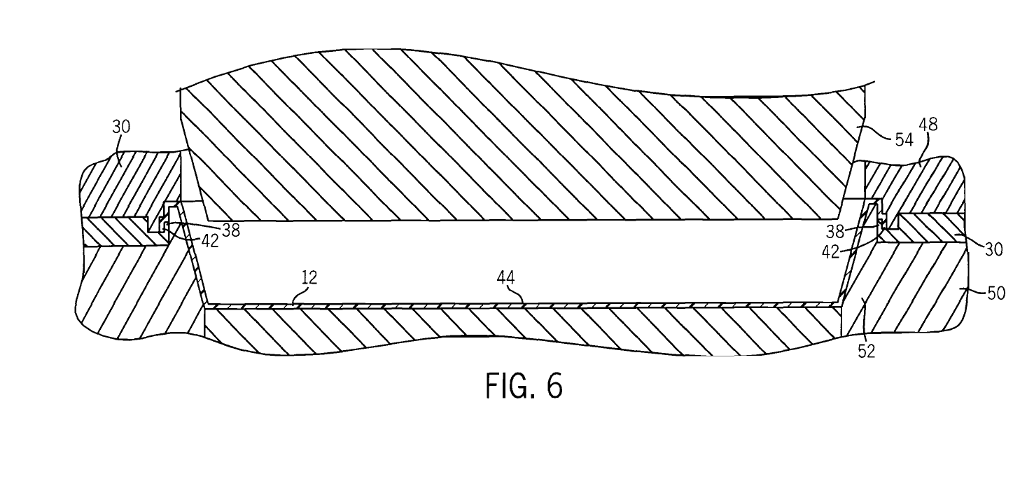

Form press 24 is known in the art and may be any one of a number of types available from a number of known suppliers. Form press 24 is used to form thermoplastic containers 26 from individual billets 12. Form press 24 permits the forming of different shaped containers 26 through the utilization of different tooling having the desired resultant configuration. The tooling typically includes a forming plug 54 (see FIG. 6) that is lowered into the heated billet 12, pushing the billet 12 down into a form cavity 52 (see FIG. 6) that is of the final container shape (see FIGS. 8 and 9). Air pressure and/or vacuum assist may be used to aid in pulling or pushing the billet 12 into the form cavity 52, and the form cavity 52 may be cooled with chilled water to permit easier release of the formed container 26.

After exiting the form press 24, transport tray 16 conveys formed containers 26 to an unloading station or removing unit 28 that removes the formed containers 26 from the transport tray 16 such that transport tray 16 may be recycled to the start of thermoformer 10 for use in conveying more billets 12.

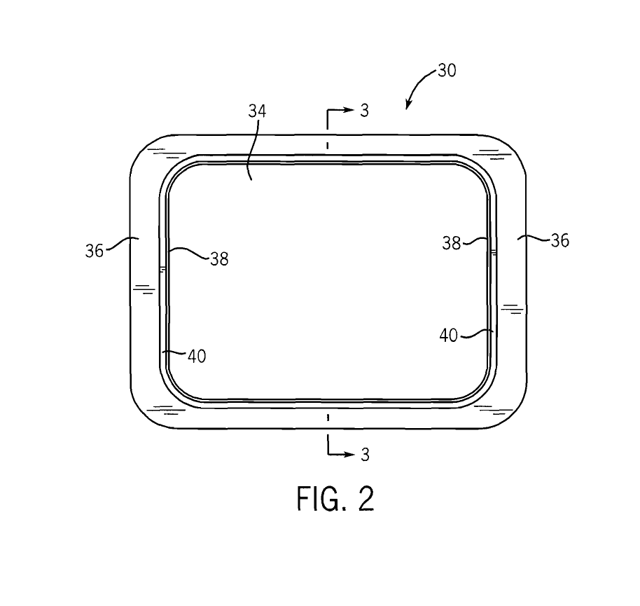

Referring to FIGS. 1 and 2, in an exemplary embodiment, transport tray 16 supports a number of rings or frames 30, each configured to support a billet 12 (not shown in FIG. 2). Billets 12 may be substantially rectangular to be received in the frame 30 of FIG. 2, but may take other shapes and sizes. The dimensions of transport tray 16 may vary depending on the size of thermoformer 10. Further, the number of frames 30 disposed on transport tray 16 is variable, depending on the desired size and shape of formed containers 26, as well as the configuration of thermoformer 10 and form press 24. Transport tray 16 may be constructed of aluminum, steel, or other materials suitable for use in thermoformer 10. Frames 30 are attached to transport tray 16 using any of a variety of suitable attachment mechanisms, such as screws or bolts.

Further referring to FIG. 1, transport tray 16 may be conveyed through thermoformer 10 by a chain drive (not shown). Thermoformer 10 may be configured to release transport tray 16 at various points in thermoformer 10 where transport tray 16 must remain stationary, such as when in form press 24.

In the exemplary embodiment depicted in FIGS. 2-6, the frame 30 is configured to support one billet 12. Billet 12 is supported at an interface between the billet 12 and frame 30. Although the frame 30 depicted in FIG. 2 is rectangular, frame 30 may be of any desired shape or size.

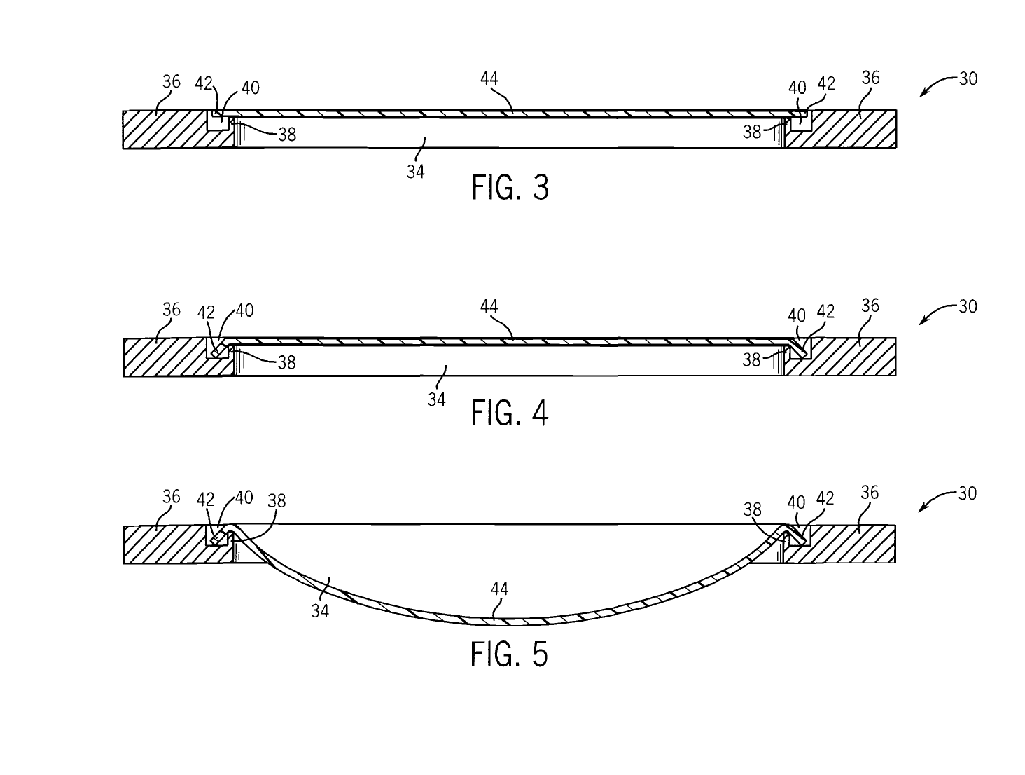

Referring to FIGS. 2-6, frame 30 includes an outer ring or perimeter portion 36 and a center cavity 34. The billet 12 is supported by a billet support, shown as, but not limited to, blade 38. Blade 38 and perimeter portion 36 define a trough or channel 40. As shown in FIG. 3, billet 12 includes an outer edge or edge portion 42 that overhangs channel 40. Center portion 44 of billet 12 is disposed over center cavity 34.

Frame 30 and blade 38 may be made of steel, aluminum, or other materials suitable for use in thermoformer 10. In a preferred embodiment, blade 38 is narrow, such as 0.05 inches across in a frame 30 having a cavity 34 dimensions of 8.5 inches by 6.5 inches. FIG. 3 depicts the relationship between billet 12 and blade 38 prior to heating of billet 12. Edge portion 42 does not extend downward into channel 40 when billet 12 is cool, as typical thermoplastic materials are relatively stiff prior to heating.

Referring to FIG. 4, coining press 20 (see FIG. 1) may be used to pre-form billet 12 such that edge portion 42 extends downward into channel 40 prior to entry into oven 22 for further heating.

The utilization of coining press 20 to pre-form edge portion 42, as shown in FIG. 4, aids in the retention of billet 12 on frame 30 as billet 12 is heated in oven 22. Further, the pre-forming of edge portion 42 may be desirable to provide a lip on formed container 26. Pre-heater 18 and coining press 20 are not essential elements of the invention, but are part of one embodiment thereof.

Referring to FIG. 5, in an exemplary embodiment, as billet 12 is heated to the desired temperature for thermoforming, edge portion 42 and center portion 44 may begin to lose rigidity and expand. The heating may result in billet 12 bulging upward due to the expansion or assuming the orientation depicted in FIG. 5, or some combination thereof, depending on the material and temperature of billet 12. Rather than sliding off or losing engagement with frame 30, the billet 12 remains on frame 30 due to engagement with blade 38.

In thermoformers 10 having an oven 22 that heats both sides of billet 12 simultaneously, frame 30 may partially shield edge portion 42 from heating in the oven (by shielding edge portion 42 from bottom element of oven 22) thereby reducing the temperature of edge portion 42 relative to center portion 44. The resulting temperature differential may result in increased stiffness of edge portion 42, aiding in retaining billet 12 on frame 30. However, in embodiments where frame 30 does not shield edge portion 42 (e.g., oven 22 having only top-heating), the blade 38 retains billet 12 on frame 30 via frictional engagement.

The combination of blade 38 and channel 40 permits positive retention of billet 12 where a shelf structure fails to do so. A shelf without channel 40 does not permit the sagging of edge portion 42, as depicted in FIG. 5, which aids in retaining billet on frame 30. Further, the narrow dimension of blade 38 in the preferred embodiment permits superior frictional engagement of billet 12 compared to wider structures. Although blade 38 is shown as a continuous wall of material in FIG. 2, the blade 38 may also take other forms, such as a segmented wall or series of posts that perform the engagement and support function suitable to retain billet 12 during heating.

Referring to FIG. 6, within form press 24, upper clamp 48 and lower holder 50 come together and engage frame 30 prior to forming container 26. Center portion 44 and edge portion 42 of billet 12 may be simultaneously formed within form press 24 through the use of upper clamp 48, lower holder 50, form cavity 52, and forming plug 54. In a preferred embodiment, billet 12 is heated to a temperature lower than the crystalline melting temperature of billet 12, such that solid-phase forming is performed within form press 24. In other embodiments, billet 12 may be heated to different temperatures, for example to a temperature at or above the melting point of billet 12 to support melt-phase thermoforming.

The use of blade 38 in conjunction with channel 40 permits greater flexibility in a thermoforming process utilizing billets 12. Because blade 38 provides a superior grip on billet 12, larger billets 12 may be heated and formed than previously possible, as larger billets 12 are subject to greater deformation when heated, and accordingly are not properly retained by conventional devices used to hold billets 12. Further, the present invention permits the thermoforming of billets 12 having various non-uniform shapes and sizes that are problematic in conventional holding devices due to the non-uniform expansion and resulting stresses when heated. Further still, the structure of the present invention obviates the necessity of providing a support structure over billet 12 in certain cases, reducing the complexity and associated cost of manufacturing formed containers 26.

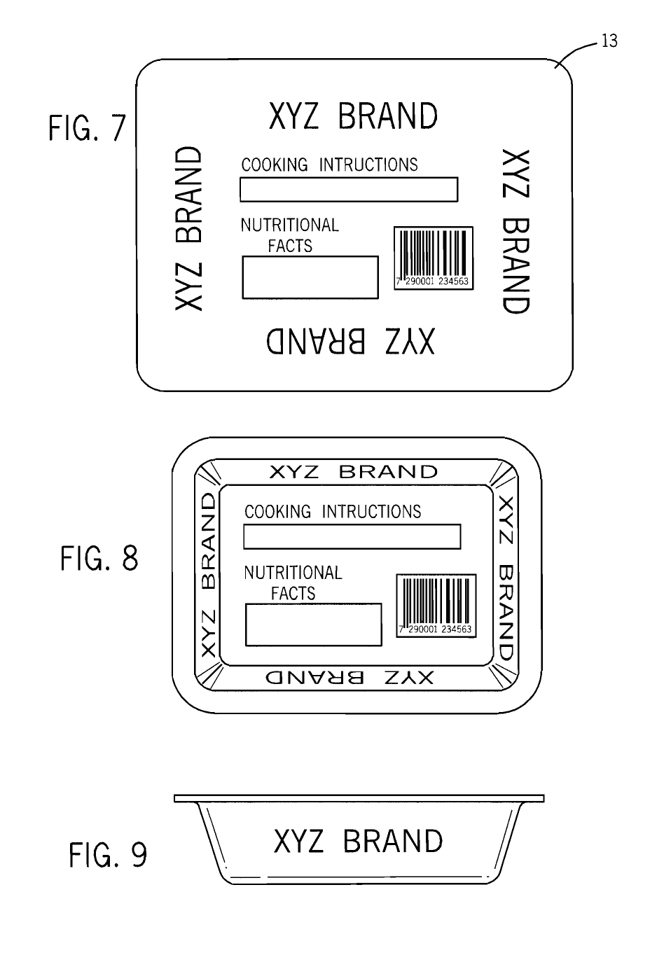

Referring to FIGS. 7-9, in an exemplary embodiment, billet 12 may be a preprinted thermoplastic blank. FIG. 7 shows one example of such a preprinted thermoplastic blank as preprinted billet 13. Preprinted billet 13 may be made from a preprinted sheet or a preprinted continuous roll of thermoforming material. Preprinted billets 13 may then be cut out (e.g. punched out) to be utilized to form containers in thermoformer 10 using the process described above for billets 12. It is to be understood that preprinted billets 13 are one embodiment of the billets 12 described herein.

Preprinted billet 13 may have printing on it (e.g. writing, designs, symbols, patterns, etc.). As shown in FIG. 7, preprinted billet 13 may contain any assortment of printed information or packaging detail, such as, but not limited to, packaging design or decoration, company name or logo, product name or information, handling and cooking instructions, and bar code symbols. Printing may be of any shape, size, color, design, etc.

Printing may be on the top side, the bottom side, or both the top and bottom sides of preprinted billet 13. When formed into a container, printing on the top side of preprinted billet 13 will be inside the formed container. A food-safe ink may be used if the printed portion of preprinted billet 13 is to be in direct contact with food. Printing on the bottom side of preprinted billet 13 will be on the outside of the formed container, as shown in FIGS. 8-9. Printing on the bottom side of preprinted billet 13 may result in placement on the outside bottom or sides of the formed container, depending on the location of the printing on preprinted billet 13 and the shape of the formed container.

The use of preprinted billet 13 in thermoforming machine 10 provides several advantages over previous packaging technologies. One such advantage is the reduction of overall packaging materials allowing for a “greener” (i.e. more environmentally friendly product) to be constructed. This is because “double packaging” is unnecessary since the thermoformed container already has all of the final packaging characteristics included on it. The need for additional sleeves, boxes, wraps, etc. is eliminated by using preprinted billet 13. Reduction of packaging material may also save time and money because additional steps to “double package” are not taken when using preprinted billet 13.

Another advantage of using a preprinted billet 13 in thermoforming machine 10 is the ability to have both simple and intricate designs, symbols and logos located in specific locations on the formed container. A barcode or other product information on preprinted billet 13 remains readable and in a predetermined location after being thermoformed into a container.

While the detailed drawings and specific examples given describe various exemplary embodiments, they serve the purpose of illustration only. It is to be understood that the invention is not limited in its application to the details of construction and the arrangements of components set forth in the preceding description or illustrated in the drawings. Furthermore, other substitutions, modifications, changes, and omissions may be made in the design, operating conditions, and arrangements of the exemplary embodiments without departing from the scope of the invention as expressed in the appended claims.

What is claimed is:

1. A thermoforming system, comprising:
a thermoplastic preprinted billet; and
a thermoforming machine, comprising:
a loading station configured to load the preprinted billet onto a frame;
a heating apparatus configured to heat the preprinted billet; and
a forming station configured to form the preprinted billet into a container.

2. The thermoforming system of claim 1, wherein the preprinted billet is printed on a top side and a bottom side.

3. The thermoforming system of claim 1, further comprising a barcode printed on the preprinted billet.

4. The thermoforming system of claim 1, further comprising product information printed on the preprinted billet.

5. The thermoforming system of claim 1, further comprising handling and cooking instructions printed on the preprinted billet.

6. The thermoforming system of claim 1, further comprising company information printed on the preprinted billet.

7. The thermoforming system of claim 1, wherein the printing on the preprinted billet is a pattern.

8. A method of using the system of claim 1, comprising:
loading the preprinted billet onto the frame;
heating the preprinted billet to a temperature suitable for thermoforming; and
forming a container from the preprinted billet.

9. The method of claim 8, wherein the preprinted billet is printed on a top side and a bottom side.

10. The method of claim 8, further comprising providing a barcode printed on the preprinted billet.

11. The method of claim 8, further comprising providing product information printed on the preprinted billet.

12. The method of claim 8, further comprising providing handling and cooking instructions printed on the preprinted billet.

13. The method of claim 8, further comprising providing company information printed on the preprinted billet.

14. A method of forming a container, comprising:
providing a plastic preprinted billet;
loading the preprinted billet onto a frame in a thermoforming machine;
heating the preprinted billet to a temperature suitable for thermoforming; and
forming a container from the preprinted billet.

15. The method of claim 14, wherein the preprinted billet is printed on a top side and a bottom side.

16. The method of claim 14, further comprising providing a barcode printed on the preprinted billet.

17. The method of claim 14, further comprising product information printed on the preprinted billet.

18. The method of claim 14, further comprising providing handling and cooking instructions printed on the preprinted billet.

19. The method of claim 14, further comprising providing company information printed on the preprinted billet.

20. The method of claim 14, further comprising providing the printing on the preprinted billet in a specific location prior to being formed whereby the formed container has printing in a specific corresponding location.
